(19) United States
(12) Patent Application Publication
(10) Pub. No.: US 2007/0041684 A1
(43) Pub. Date: Feb. 22, 2007

(54) Switchable viewfinder display

(75) Inventors: Milan Momcilo Popovich, Leicester (GB); Eric James Hansotte, Sunnyvale, CA (US)

Correspondence Address: Milan M Popovich;Creative Physics Ltd, 53 Westfield Road, Leicester, England, LE3 6HU, GB

(73) Assignee: SBG Labs Inc. a Delaware Corporation, Sunnyvale, CA (US)

(21) Appl. No.: 10/555,661

(22) PCT Filed: May 6, 2004
(86) PCT No.: PCT/US04/14124

§ 371 Date: Jan. 24, 2006

Related U.S. Application Data
(60) Provisional application No. 60/469,471, filed on May 9, 2003.

(51) Int. Cl. G02B 6/34

(52) U.S. Cl. 385/37

(57) ABSTRACT

A compact high quality and lightweight symbol generator for projecting symbolic information into the field of view of a viewfinder is provided. The symbol generator comprises at least one ESBG device sandwiched between a pair of transparent plates which together function as a total internal reflection lightguide, switching electrodes and means for coupling illumination into the lightguide. Each ESBG device contains information encoded in a multiplicity of separately switchable grating regions. A plurality of independently switchable transparent electrodes elements, substantially overlay the separately switchable grating regions. When no electric field is applied, the ESBG device is in its diffracting state and projects images of said information towards the viewer. The projected images are surimposed onto an image of the external scene. When an electric field is applied the ESBG no longer diffracts and hence3 no information is displayed. In a further embodiment of the invention, the symbol generator could be configured to provide symbols of different colors by arranging for different symbols to contain ESBGs optimized for the required wavelengths and LEDs of appropriate spectral output. In a yet further embodiment of the basic invention several ESBG panels could be stacked such that by selectively switching different layers it is possible to present a range of different symbols of differing colors at any specified location in the field of view.

This application claims the benefit of U.S. Provisional Patent Application No. 60/469,471 filed May 9, 2003 entitled “Switchable Viewfinder Display”.

### BACKGROUND OF THE INVENTION

This invention relates to a display device, and more particularly to a switchable grating device suitable for displaying information in the viewfinder of a camera or similar optical system.

Optical viewing systems such as cameras, night vision equipment and optical sights often have a requirement to selectively present symbolic information of various types superimposed over the view of the outside scene. Static information may be displayed in a viewfinder by the simple method of placing an etched reticule at an image plane within the optical system, such as the reticules commonly found in the eyepieces of microscopes. A number of schemes are used to present dynamic information, including selective illumination of symbology engraved on a reticule, or the use of a beamsplifter to combine the information presented on a small display device with the outside scene.

In some optical systems, however, a suitable image plane may not be available for the insertion of display information. In the case of a single lens reflex camera, a diffusing screen may be placed at the image plane within the viewfinder. In other optical systems, the image plane may exist within an optical element such as a prism.

It is well known that diffractive optical elements are ideally suited to projection of symbology. Bragg gratings (also commonly termed volume phase grating or holograms), which offer the highest diffraction efficiencies, have been widely used in devices such as Head Up Displays.

U.S. Pat. No. 6,052,540 by Koyama discloses a viewfinder device comprising a transmission hologram that can be located at a position other than in an image plane. The position of the virtual image formed by the transmission hologram is arranged to lie at the image plane of the optical system. Since the virtual image of the display is outside of the physical limit of the hologram element, the virtual image can be arranged to be coincident or within another optical element such as a diffuser or prism. The '540 device suffers from the problem that it may introduce objectionable obstruction of the outside scene, since a hologram that diffracts light from the illumination source to the observer will also inevitably diffract light from the outside scene away from the observer. For example, if the hologram is designed for illumination by a red light emitting diode, the hologram will also diffract red light from the outside scene away from the viewer. Thus, without illumination, the display symbology will be visible in reverse color, blue-green in this case, against the outside scene due to the absence of the red light diffracted by the hologram.

An important class of diffractive optical element known as an Electrically Switchable Bragg Gratings (ESBG) is based on recording Bragg gratings into a polymer dispersed liquid crystal (PDLC) mixture. Typically, ESBG devices are fabricated by first placing a thin film of a mixture of photopolymerisable monomers and liquid crystal material between parallel glass plates. One or both glass plates support electrodes, typically transparent indium tin oxide films, for applying an electric field across the PDLC layer. A Bragg grating is then recorded by illuminating the liquid material with two mutually coherent laser beams, which interfere to form the desired grating structure. During the recording process, the monomers polymerize and the PDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting Bragg grating can exhibit very high diffraction efficiency, which may be controlled by the magnitude of the electric field applied across the PDLC layer. In the absence of an applied electric field the ESBG remains in its diffracting state. When an electric field is applied to the hologram via the electrodes, the natural orientation of the LC droplets is changed thus reducing the refractive index modulation of the fringes and causing the hologram diffraction efficiency to drop to very low levels. The diffraction efficiency of the device can be adjusted, by means of the applied voltage, over a continuous range from essentially zero to near 100%.

U.S. Pat. No. 5,942,157 by Sutherland et al. and U.S. Pat. No. 5,751,452 by Tanaka et al. describe monomer and liquid crystal material combinations suitable for fabricating ESBG devices. A recent publication by Butler et al. (“Diffractive properties of highly birefringent volume gratings: investigation”, Journal of the Optical Society of America B, Volume 19 No. 2, February 2002) describes analytical methods useful to design ESBG devices and provides numerous references to prior publications describing the fabrication and application of ESBG devices. Japanese patent JP2002090858, by Masakata, describes the use of a LED illuminated switchable hologram device as a display in a viewfinder for a single lens reflex camera. Since the hologram device can be switched to a substantially clear state, the viewfinder described in this patent will have reduced obstruction of the outside scene when the display is off. However, this device is difficult to integrate within typical camera assemblies due to the volume occupied by the LED illumination system.

There is a requirement for viewing devices that minimize size and weight while satisfying stringent visual optical requirements for high contrast, high resolution and freedom from glare, scatter, or any other impairment of the external scene onto which the symbolic data is superimposed. It is an objective of the apparatus described in the present disclosure to provide a compact high quality and lightweight device for projecting symbology into the field of view of a viewfinder.

### SUMMARY OF THE INVENTION

It is an object of the present invention to provide a compact high quality and lightweight symbol generator for projecting symbolic information into the field of view of a viewfinder.

The objects of the invention are achieved in a first embodiment comprising at least one ESBG device sandwiched between a pair of transparent plates which together function as a total internal reflection lightguide, switching electrodes and means for coupling illumination into the lightguide. Each ESBG device contains information encoded in a multiplicity of separately switchable grating regions. A plurality of independently switchable transparent electrodes elements, substantially overlay the separately switchable grating regions. When no electric field is applied, the ESBG device is in its diffracting state and projects images of said information towards the viewer. The projected images are superimposed onto an image of the external scene. When an electric field is applied the ESBG no longer diffracts and hence no information is displayed.

In a further embodiment of the invention, the symbol generator could be configured to provide symbols of different colors by arranging for different symbols to contain ESBGs optimized for the required wavelengths and LEDs of appropriate spectral output.

In a yet further embodiment of the basic invention several ESBG panels could be stacked such that by selectively switching different layers it is possible to present a range of different symbols at any specified point in the field of view.

A more complete understanding of the invention can be obtained by considering the following detailed description in conjunction with the accompanying drawings, wherein like index numerals indicate like parts. For purposes of clarity, details relating to technical material that is known in the technical fields related to the invention have not been described in detail.

### BRIEF DESCRIPTION OF THE DRAWINGS

FIG. 1 is a schematic unfolded side view of a symbol generator according to the basic principles of the invention integrated within a Single Lens Reflex (SLR) camera.

FIG. 2 is a schematic side view of the symbol generator.

FIG. 3 is a chart illustrating the diffraction efficiency versus incident angle of an ESBG in the state in which no electric field is applied to the ESBG.

FIG. 4 is a schematic side view of the exposure system to create the ESBG.

### DETAILED DESCRIPTION OF THE INVENTION

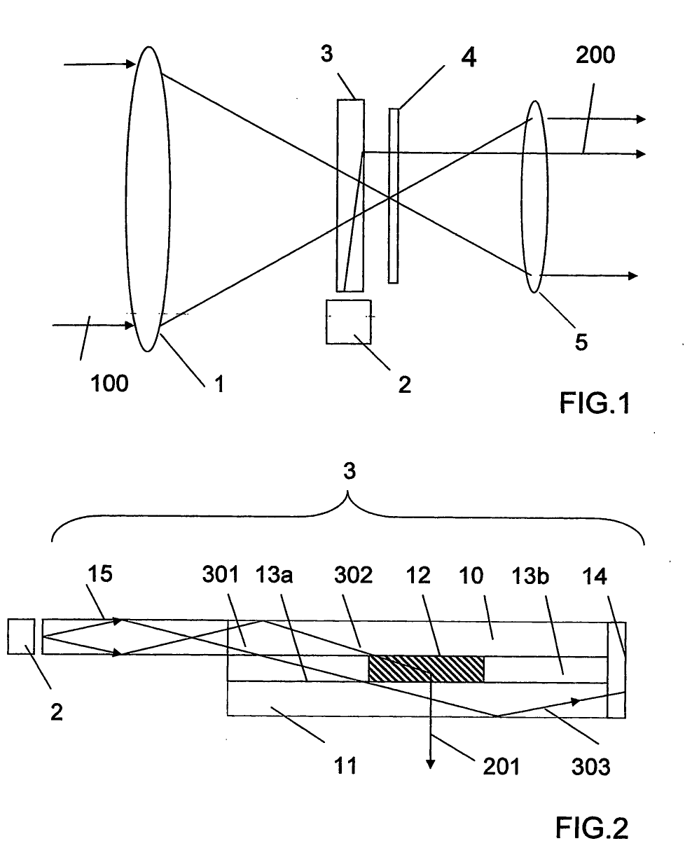

The invention will now be further described by way of example only with reference to the accompanying drawings. FIG. 1 shows a schematic unfolded side view of a Single Lens Reflex camera comprising an objective lens 1 which forms a focused image of an external scene on a diffusing screen 4, a symbol generator 3 which projects images of symbols onto said screen, a Light Emitting Diode (LED) 2 optically coupled to the symbol generator and an eyepiece lens 5 through which an image of the scene can be viewed. The symbol generator is transparent to external light rays generally indicated by 100. In FIG. 1 the path of the light from the symbol generator is generally indicated by the ray 200. By placing the screen at the focal point of the eyepiece an image of the external scene with superimposed symbolic data is formed at some nominal comfortable viewing distance. The objective lens 1 and the diffusing screen 4 do not form part of the invention.

Turning now to FIG. 2 in which the symbol generator 3 is again illustrated in a schematic side view, it will be seen that the symbol generator comprises, a lightguide 15, a beam stop 14, a pair of transparent substrates 10 and 11, and an ESBG region sandwiched between the substrates comprising at least one grating region 12 and a flood cured regions 13a,13b on either side of the ESBG grating region. The grating region has a first surface facing the viewer and a second face. A set of transparent electrodes, which are not shown, is applied to both of the inner surfaces of the substrates. The electrodes are configured such that the applied electric field will be perpendicular to the substrates. Typically, the planar electrode configuration requires low voltages, in the range of 2 to 4 volts per μm. The electrodes would typically be fabricated from Indium Tin Oxide (ITO). The two substrates 10 and 11 together form a light guide. The input lightguide 15 is optically coupled to the substrates 10 and 11 such the light from the LED undergoes total internal reflection inside the lightguide formed by 10 and 11. Light from the external scene, generally indicated as 101 propagates through the symbol generator onto the screen where it forms a focused image of the external scene. The function of the symbol generator may be understood by considering the propagation of rays through the symbol generator in the state when the ESBG is diffracting, that is with no electric field applied. The rays 301 and 302 emanating from the light source 2 are guided initially by the input lightguide 15. The ray 302 which impinges on the second face of the grating region 12 is diffracted out of the symbol generator in the direction 201 towards the screen where an image of the symbol holographically encoded in the ESBG is formed. On the other hand, the rays 301 which do not impinge on the grating region 12 will hit the substrate-air interface at the critical angle and are totally internally reflected in the direction 303 and eventually collected at the beam stop 14 and out of the path of the incoming light 101.

The grating region 12 of the ESBG contains slanted fringes resulting from alternating liquid crystal rich regions and polymer rich (ie liquid crystal depleted) regions. In the OFF state with no electric field applied, the extraordinary axis of the liquid crystals generally aligns normal to the fringes. The grating thus exhibits high refractive index modulation and high diffraction efficiency for P-polarized light.

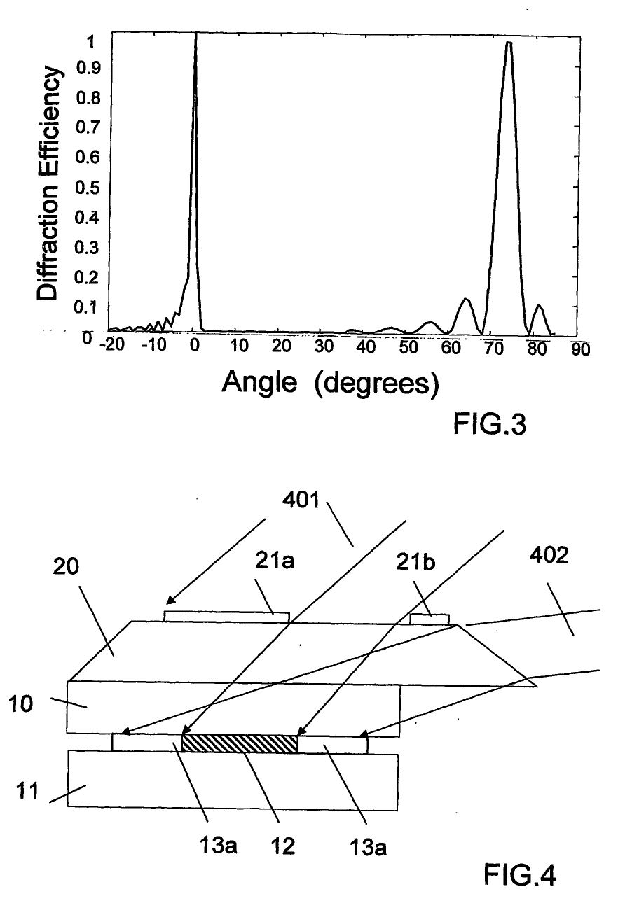

FIG. 3 is a chart illustrating the diffraction efficiency versus angle of an ESBG grating in the OFF state. This particular grating has been optimized to diffract red light incident at around 72 degrees (the Bragg angle) with respect to the normal of the substrate. The Bragg angle is a function of the slant of the grating fringes and is chosen such that the diffracted light exits close to normal (0 degrees) to the substrate 11 in order to be captured by the eyepiece 5. To maximize the light throughput from the light source 2 to the eyepiece 5, the light source and input lightguide should be configured such that light is launched into the lightguide at the Bragg angle. This can be accomplished by various means well known to those skilled in the art, including the use of lenses. Light launched into the lightguide must be at an angle greater than the angle for Total Internal Reflection (TIR) in order to be guided by the lightguide. Hence, the Bragg angle must be chosen to be larger than the angle for TIR.

When an electric field is applied to the ESBG, the grating switches to the ON state wherein the extraordinary axes of the liquid crystal molecules align parallel to the applied field and hence perpendicular to the substrate. Note that the electric field due to the planar electrodes is perpendicular to the substrate. Hence in the ON state the grating exhibits lower refractive index modulation and lower diffraction efficiency for both S- and P-polarized light. Thus the grating region 12 no longer diffracts light into the eyepiece and hence no symbol is displayed.

In order to ensure high transparency to external light, high contrast of symbology (ie high diffraction efficiency) and very low haze due to scatter the following material characteristics are desirable.
a) A low index modulation residual grating with a modulation not greater than 0.007. This will require a good match between the refractive index of the polymer region and the ordinary index of the liquid crystal.
b) High index modulation capability with a refractive index modulation not less than 0.06
c) Very low haze for cell thicknesses in the range 2-6 micron
d) A good index match (to within ±0.015) for glass or plastic at 630 nm. One option is 1.515 (for example, 1737F or BK7 glasses). An alternative option would be 1.472 (for example Borofloat or 7740 Pyrex glasses)

FIG. 4 is a schematic side elevation view of a laser exposure system used to record the ESBG grating. The exposure system comprises a prism 20 mount on top of and in optical contact with the substrate 10, a mask for defining the shapes of the symbols to be projected containing opaque regions such as 21a and 21b, and two mutually coherent intersecting laser beams generally indicated by 401 and 402. The prism has a top surface substantially parallel to the substrate and angle side faces. The beam 401 is introduced via the top surface of the prism. The beam 402 is introduced via a side face of the prism. The mask defines an aperture through which portions of the beams can impinge on the mixture of photopolymerisable monomers and liquid crystal material confined between the parallel substrates 10 and 11. The interference of the beam within the region defined by the aperture creates a grating region 12 comprising alternating liquid crystal rich and polymer rich regions. The shape of the aperture defines the shape of the symbol. It will be clear from consideration of FIG. 4 that a plurality of symbols may be created in this way.

Each symbol may be independently controlled by an independent pair of planar electrodes. Typically, the electrode on one substrate surface is uniform and continuous, while electrodes on the opposing substrate surface are patterned to match the shapes of the said ESBG symbols regions. Desirably, the planar electrodes should be exactly aligned with the ESBG symbol regions for optimal switching of the symbols and the elimination of any image artifacts that may result from unswitched grating regions.

Referring again to FIG. 4 we see that the flood-cured regions 13a, 13b are created by the beam 402. Since there is no intensity variation in this region, no phase separation occurs and the region is homogeneous, haze-free and generally does not respond to applied electric fields.

In one practical embodiment of the invention directed at SLR cameras the symbol generator would have a square aperture of side dimension equal to 30 mm. The beam inside the light guide would have an incidence angle of 72 degrees corresponding to the Bragg angle of the ESBG grating.

In a further embodiment of the invention, the symbol generator could be configured to provide symbols of different colors by arranging for different symbols to contain ESBGs optimized for the required wavelengths and LEDs of appropriate spectral output.

In a yet further embodiment of the basic invention several ESBG panels could be stacked such that by selectively switching different layers it is possible to present a range of different symbols at any specified point in the field of view.

Although in FIGS. 1-2 the light source is coupled to the symbol generator by means of a light guide, other methods involving prisms, lenses or diffractive optical elements may be used.

Although the invention has been described in relation to what are presently considered to be the most practical and preferred embodiments, it is to be understood that the invention is not limited to the disclosed arrangements but rather is intended to cover various modifications and equivalent constructions included within the spirit and scope of the invention.

What is claimed is:

1. A symbol generator for presenting information in an optical viewfinder comprising:
a first ESBG device having a front side facing towards the viewer and a rear side;
wherein said ESBG is sandwiched between first and second transparent plates;
wherein said transparent plates together function as a light guide;
wherein each said ESBG device contains information encoded in a multiplicity of separately switchable grating regions;
a plurality of independently switchable transparent electrodes elements, said independently electrodes substantially overlaying said separately switchable grating regions; and
means for coupling illumination into said transparent plates;
said ESBG being operative to project the images of said information towards said viewer when said ESBG rear side is illuminated using light of a first wavelength and no electric field is applied to said ESBG.

2. The symbol generator of claim 1, wherein said ESBG device provides a grating within each of said separately switchable regions and is clear elsewhere.

3. The symbol generator of claim 1, wherein said illumination means provides linearly polarized light.

4. The symbol generator of claim 1, wherein said illumination means is a Light Emitting Diode.

5. The symbol generator of claim 1, wherein said illumination means provides light having a limited bandwidth centered about a wavelength, and the maximum diffraction efficiency of said ESBG device occurs at approximately the same wavelength.

6. The symbol generator of claim 8, wherein said wavelength is about 620 nanometers.

7. The symbol generator of claim 1, wherein said separately switchable grating regions provide images of symbols.

8. The symbol generator of claim 1, further comprising an external diffuser.

9. The symbol generator of claim 1, wherein said separately switchable grating regions are configured to diffract light at different wavelength provided by a multiplicity of light sources of appropriate spectral output.

10. The symbol generator of claim 3, further comprising a third transparent plate and a second ESBG sandwiched between said second and third transparent plates;
wherein said first, second and third transparent plates together function as a light guide;
wherein each said second ESBG device contains information encoded in a multiplicity of separately switchable grating regions;
wherein said switchable grating regions of said first and second ESBGs substantially overlap;
said second ESBG being operative to project the images of said information towards said viewer when said ESBG rear side is illuminated using light of a second wavelength and no electric field is applied to said second ESBG.
